(19) United States
(12) Patent Application Publication
(10) Pub. No.: US 2023/0151191 A1
(43) Pub. Date: May 18, 2023

(54) RUBBER-BASED PUNCTURE SEALING AGENT FOR TIRES

(71) Applicant: Sumitomo Rubber Industries, Ltd., Kobe-shi (JP)

(72) Inventors: Angel J. JIMENEZ, Kobe-shi (JP); Christoph T. KERN, Kobe-shi (JP)

(73) Assignee: Sumitomo Rubber Industries, Ltd., Kobe-shi (JP)

(21) Appl. No.: 17/979,826

(22) Filed: Nov. 3, 2022

(30) Foreign Application Priority Data
Nov. 15, 2021 (DE) 102021129755.9

(51) Int. Cl. C08L 7/02

(52) U.S. Cl. CPC C08L 7/02; C08L 2205/035

(57) ABSTRACT

A puncture sealing agent is disclosed which comprises a rubber latex, a carbohydrate, an additional polymer, and an antifreeze agent. The sealing agent can be used for repairing or preventing punctures in tubeless tires as well as tires having an inner tube, in particular in bicycle tires and e-scooter tires.

### CROSS-REFERENCE TO RELATED APPLICATION

The present application claims priority to German Patent Application No. 102021129755.9, filed Nov. 15, 2021. The entire content and disclosure of the foregoing application is incorporated herein by reference.

The present invention is related to a puncture sealing agent having an excellent sealing performance for use in a puncture repair system.

In tire puncture repair systems, a puncture sealing agent is used for sealing punctures in pneumatic tires. The puncture sealing agent is a liquid comprising a solid dispersion and is injected into a damaged tire. The tire is then filled with air with the aid of a compressor and can be used to travel in that condition. When traveling, the puncture sealing agent is shaken within the tire, and as a result, the solid content of the dispersion is deposited to cover the puncture hole.

In recent years the required level of performance for puncture sealing agents has increased. Most of the efforts have been put into improving the sealant performance, injectability, and/or the applicability in low-temperature environments while maintaining ideal storage performance.

Furthermore, the increasing popularity of tubeless bicycle tires for different bike types, such as electric bicycles (e-bikes), mountain bikes or cargo bikes, has led to surging demand for puncture sealing agents which are optimized for such tires. On the other hand, many bicycles, but also other vehicles such as electric scooters (e-scooters), bicycle trailers or children's bicycles, are still equipped with tires having inner tubes. However, having to purchase, store, and/or carry with oneself different specialized sealing agents for different vehicles (for example, one for the bicycle and another one for the bicycle trailer) is cumbersome to the user.

Therefore, a need exists for a sealing agent which is capable of sealing punctures in tubeless tires as well as in tires having an inner tube.

Puncture sealing agents contain usually synthetic components for improving the sealing performance, injectability and/or the applicability in low-temperature environments while maintaining ideal storage performance. However, using synthetic components is not resource saving and environmentally friendly. In addition, there is room for improving the sealing properties of puncture sealing agents having sufficient low temperature injectabilities.

A puncture sealant agent is described in JP 2015-98538 A, wherein natural rubber is contained in an amount such that the solid content derived from natural rubber is 25% by weight, based on the total weight of the puncture sealant agent, together with a rosin resin having a softening point of 90° C. and propane-1,3-diol. In US 2015/0175862 A1, a further puncture sealing agent is described which contains a rubber latex, propane-1,3-diol and a resin emulsion as tackifier, such as a terpene resin. However, there remains room for improvement with regard to low temperature injectability and seal retention performance.

In view of the above, the object underlying the present invention is to provide a puncture sealing agent which is resource saving, environmentally friendly and has a sealing performance, injectability, and applicability in low-temperature environments comparable or superior to conventionally used puncture sealing agents based on synthetic components, while being capable of sealing punctures in both tubeless tires and tires having an inner tube.

In accordance with the present invention, this object is achieved by a puncture sealing agent according to claim 1.

This solution is based on the surprising finding that, by combining in a puncture sealing agent a rubber latex, a carbohydrate, an additional polymer and an antifreeze agent, a puncture sealing agent can be obtained which is at least primarily based on natural components and therefore resource saving and environmentally friendly. It was found that such a puncture sealing agent provides excellent sealing performance, injectability and applicability in both low-temperature and high-temperature environments. In particular, it was found that injection of such a puncture sealing agent into a tire is even possible when using only a manually operated air pump, such as a bicycle air pump, thus eliminating the need for a compressor and allowing, for instance, the use of the sealing agent for emergency repairs of punctured bicycle tires. Moreover, it was found that the puncture sealing agent can also be used for preventing punctures in tires by injecting it into a tire which is still intact. It was further discovered that the sealing agent can be used for the repair or prevention of punctures in tubeless tires as well as in tires having an inner tube. Furthermore, it was found that a puncture sealing agent according to the present invention has a long shelf-life. In addition, by using carbohydrates as adhesives, it is possible to significantly reduce the costs for the puncture sealing agent, since the use of synthetic resins can be reduced or completely avoided. Accordingly, it is possible to reduce or even avoid the use of dangerous compounds and additives. Moreover, disposal of the puncture sealing agent according to the invention after expiry is easy and non-dangerous.

Preferably, the puncture sealing agent according to the present invention is a bicycle tire puncture sealing agent.

Another aspect of the present invention is the use of the puncture sealing agent according to the present invention for repairing punctured tubeless tires, preferably punctured tubeless bicycle tires or punctured tubeless e-scooter tires.

Another aspect of the present invention is the use of the puncture sealing agent according to the present invention for repairing punctured tires having an inner tube, preferably punctured bicycle tires or e-scooter tires having an inner tube.

A further aspect of the present invention is the use of the puncture sealing agent according to the present invention for preventing punctures in tubeless tires, preferably in tubeless bicycle tires or tubeless e-scooter tires.

A further aspect of the present invention is the use of the puncture sealing agent according to the present invention for preventing punctures in tires having an inner tube, preferably in bicycle tires or e-scooter tires having an inner tube.

Preferred embodiments of the present invention are the subject-matter of dependent claims and described subsequently along with further preferred embodiments which are not expressly mentioned in the dependent claims.

The rubber latex contained in the puncture sealing agent according to the present invention is preferably natural rubber (NR) latex, polyisoprene rubber (IR) latex, styrene-butadiene rubber (SBR) latex, polybutadiene rubber (BR) latex, butyl rubber (IIR) latex, chlorobutyl rubber (CIIR), bromobutyl rubber (BIIR) latex, acrylonitrile-butadiene rubber (NBR) latex, chloroprene rubber latex (CIIR), ethylene propylene diene rubber (EPDM) latex, or a mixture thereof. From the point of view of increased environmental sustainability, the rubber latex is more preferably natural rubber (NR) latex. Specific examples of the natural rubber latex include, but are not limited to, the ones obtained from Hevea brasiliensis by tapping, so-called “deproteinized natural rubber latex”, which is a protein-free natural rubber latex, and ammonia-free natural rubber latex. From the point of view of prevention of offensive odor, the rubber latex is even more preferably ammonia-free natural rubber latex. Ammonia-free natural rubber latex is produced by rubber plantations for example in Thailand, Indonesia, India and Malaysia.

It is particularly preferred when the rubber latex in the puncture sealing agent according to the invention is natural rubber latex. In such a case the components of the puncture sealing agent can be based on natural raw materials and therefore the puncture sealing agent can be resource-saving and environmentally friendly. It was further found that such a puncture sealing agent comprising ammonia-free natural rubber latex shows the same performance as a puncture sealing agent comprising conventional, ammonia-containing natural rubber latex and does not have an unpleasant smell. Furthermore, by employing rubber latex, such as natural rubber latex, and carbohydrates, it is possible to avoid the addition of synthetic resins, and to obviate the use and the release of potentially noxious compounds. Hence, the use as well as the disposal of the puncture sealing agent according to the invention is easy and non-dangerous.

The rubber latex is preferably present in the puncture sealing agent in an amount of at least 5% by weight, more preferably at least 10% by weight, even more preferably at least 15% by weight, and most preferably at least 20% by weight, based on the total weight of the puncture sealing agent. If less than 5% by weight of rubber latex is contained in the puncture sealing agent, there is a risk that sealing of the puncture in the tire is insufficient or too slow and that the sealant performance is deteriorated. Additionally, the rubber latex is preferably present in the puncture sealing agent in an amount of 45% by weight or less, more preferably 40% by weight or less, even more preferably 35% by weight or less, and most preferably 30% by weight or less, based on the total weight of the puncture sealing agent. With the amount of rubber latex being less than 45% by weight, good injectability and storage performance as well as applicability in low-temperature environments can be obtained. It is to be understood that, based on the total weight of the puncture sealing agent, the rubber latex is preferably present in the puncture sealing agent in an amount of 5% to 45% by weight, more preferably in the range of 10% to 40% by weight, even more preferably in the range of 15% to 35%, and most preferably in the range of 20% to 30% by weight, based on the total weight of the puncture sealing agent. However, also ranges of 5% to 40% by weight, 10% to 45% by weight, 20% to 40% by weight, as well as other ranges resulting from other combinations of the upper and lower limits mentioned above constitute preferred embodiments of the present invention. When the rubber latex being is present in an amount which is within the ranges described above, the above-mentioned effects can be advantageously achieved. However, it is also possible to have the amount of rubber latex outside the above indicated ranges.

The solid content of the rubber latex is preferably at least 30% by weight, more preferably at least 40% by weight, even more preferably at least 50% by weight, and most preferably at least 55% by weight, based on the total weight of the rubber latex. Additionally, the solid content of the rubber latex is preferably 80% by weight or less, more preferably 75% by weight or less, even more preferably 70% by weight or less, and most preferably 65% by weight or less, based on the total weight of the rubber latex. Herein, the solid content of the rubber latex is meant to include the combined weight of all rubbery solids and the weight of all non-rubber solids which may be dissolved or suspended in the rubber latex. It is to be understood that, based on the total weight of the rubber latex, the solid content of the rubber latex is preferably in the range of 30% to 80% by weight, more preferably in the range of 40% to 75% by weight, even more preferably in the range of 50% to 70%, and most preferably in the range of 55% to 65% by weight, based on the total weight of the rubber latex. However, also ranges of 30% to 75% by weight, 40% to 80% by weight, 55% to 75% by weight, as well as other ranges resulting from other combinations of the upper and lower limits mentioned above constitute preferred embodiments of the present invention. With the solid content of the rubber latex being within the ranges described above, a good balance between sealant performance and storage performance can be obtained.

The solid content resulting from the rubber latex in the puncture sealing agent is not particularly limited. However, it is preferably at least 2% by weight, more preferably at least 5% by weight, even more preferably at least 10% by weight, and most preferably at least 12.5% by weight, based on the total weight of the puncture sealing agent. Additionally, the solid content resulting from the rubber latex in the puncture sealing agent is preferably 35% by weight or less, more preferably 25% by weight or less, even more preferably 20% by weight or less, and most preferably 17.5% by weight or less, based on the total weight of the puncture sealing agent. It is to be understood that the solid content resulting from the rubber latex in the puncture sealing agent is preferably in the range of 2% to 35% by weight, more preferably in the range of 5% to 25% by weight, even more preferably in the range of 10% to 20%, and most preferably in the range of 12.5% to 17.5% by weight, based on the total weight of the puncture sealing agent. However, also ranges of 2% to 25% by weight, 5% to 35% by weight, 12.5% to 25% by weight, as well as other ranges resulting from other combinations of the upper and lower limits mentioned above constitute preferred embodiments of the present invention. With the solid content resulting from the rubber latex in the puncture sealing agent being within the ranges described above, the effects of the present invention can be better achieved.

The carbohydrate contained in the puncture sealing agent of the present invention may comprise one or more monosaccharides, one or more disaccharides, one or more oligosaccharides, or a mixture thereof. Preferably, the carbohydrate consists of one or more monosaccharides, one or more disaccharides, one or more oligosaccharides, or a mixture thereof. More preferably, the carbohydrate consists of one or more monosaccharides, one or more disaccharides or a mixture thereof. Even more preferably, the carbohydrate consists of one or more disaccharides. Most preferably, the carbohydrate consists of one disaccharide.

In the present specification, the term “oligosaccharides” refers to saccharides composed of 3 to 10 monosaccharide residues, and the term “polysaccharides” refers to saccharides composed of more than 10 monosaccharide residues, as defined by the IUPAC Recommendations 1995, published in Pure & Appl. Chem., Vol. 67, No. 8/9, pp. 1307-1375.

The one or more monosaccharides may be trioses, tetroses, pentoses, hexoses or heptoses, with hexoses and pentoses being particularly preferred. Some specific examples for monosaccharides are glycerinaldehyde, dihydroxyacetone, erythrose, threose, erythrulose, ribose, arabinose, xylose, lyxose, ribulose, xylulose, allose, altrose, gloxose, mannose, culose, idose, galactose, talose, psicose, fructose, glucose, fuculose, sorbose, tagatose, sedoheptulose, mannoheptulose, taloheptulose, alloheptulose, glucoheptose and mannoheptose. The one or more monosaccharides are preferably selected from fructose, galactose, glucose, mannose and xylose, more preferably from fructose and glucose.

Some specific examples for disaccharides include sucrose, lactulose, lactose, maltose, trehalose, cellobiose, chitobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose and xylobiose. The one or more disaccharides are preferably selected from cellobiose, lactose, maltose, sucrose and trehalose, more preferably from lactose, maltose and sucrose, even more preferably from lactose and sucrose. Most preferably, the disaccharide is sucrose.

In a preferable embodiment, hydrolysates of starch, for example glucose syrup and/or glucose-fructose syrup or dextrin are used as the carbohydrate, since when using these, the costs for the puncture sealing agent are reduced. Dextrin, glucose syrup and glucose-fructose syrup are liquid starch hydrolysates including mono-, di-, and oligosaccharides and can be made from any source of starch, for example from wheat, tapioca and potatoes. More preferably, the carbohydrate used is sucrose, glucose, fructose or a mixture of two or more of these. The use of sucrose is particularly preferred under the aspect of storage stability.

It is highly preferable that the puncture sealing agent according to the invention comprises at least one selected from the group consisting of sucrose, glucose, fructose and mixtures of two or more of these carbohydrates. Most preferably, the carbohydrate is sucrose.

In the puncture sealing agent according to the present invention, the carbohydrate is preferably included in the form of an aqueous solution, i.e. the carbohydrate is dissolved. To avoid precipitation of the carbohydrate in the adhesive composition, it is further preferable that the carbohydrate has a water solubility at 20° C. of 100 g/L or more, more preferably of 300 g/L or more.

In this regard, it is also preferable that, in the aqueous solution of the carbohydrate, the mass ratio (Za:Zb) of mass of carbohydrate (Za) to mass of solvent (Zb) is in the range of from 90:10 to 50:50, more preferably in the range of from 80:20 to 55:40 and even more preferably in the range of from 70:30 to 60:40. If the ratio is greater than 90:10, there is a risk that the viscosity of the aqueous solution of the carbohydrate is increased and that the injectability is deteriorated. However, if the ratio is below 50:50, the time for sealing a puncture may increase and the sealing performance may be deteriorated.

The amount of the carbohydrate contained in the puncture sealing agent can be varied in a broad range. The amount of carbohydrate contained in the puncture sealing agent is preferably at least 0.1% by weight, more preferably at least 0.5% by weight, even more preferably at least 1% by weight, most preferably at least 2% by weight, based on the total weight of the puncture sealing agent. Additionally, the amount of the carbohydrate contained in the puncture sealing agent is preferably 15% by weight or less, more preferably 10% by weight or less, even more preferably 7% by weight or less, most preferably 4% by weight or less, based on the total weight of the puncture sealing agent. It is to be understood that the amount of carbohydrate contained in the puncture sealing agent is preferably in the range of 0.1% to 15% by weight, more preferably in the range of 0.5% to 10% by weight, even more preferably in the range of 1% to 7% by weight, and most preferably in the range of 2% to 4% by weight, based on the total weight of the puncture sealing agent. However, also ranges of 0.1% to 10% by weight, 0.5 to 15% by weight, 2 to 10% by weight, as well as other ranges resulting from other combinations of the upper and lower limits mentioned above constitute preferred embodiments of the present invention. With the content of the carbohydrate being within the ranges described above, the effects of the present invention can be better achieved.

The weight ratio of the amount of rubber latex present in the puncture sealing agent to the amount of the carbohydrate in the puncture sealing agent is preferably at least 1:1, more preferably at least 2:1, even more preferably at least 4:1, and most preferably at least 6:1. Additionally, the weight ratio of the amount of rubber latex present in the puncture sealing agent to the amount of the carbohydrate in the puncture sealing agent is preferably 50:1 or less, more preferably 25:1 or less, even more preferably 15:1 or less, and most preferably 10:1 or less. It is to be understood that the weight ratio of the amount of rubber latex present in the puncture sealing agent to the amount of the carbohydrate in the puncture sealing agent is preferably in the range of 1:1 to 50:1, more preferably in the range of 2:1 to 25:1, even more preferably in the range of 4:1 to 15:1, and most preferably in the range of 6:1 to 10:1. However, also ranges of 1:1 to 25:1, 2:1 to 50:1, 6:1 to 25:1, as well as other ranges resulting from other combinations of the upper and lower limits mentioned above constitute preferred embodiments of the present invention. With the weight ratio of the amount of rubber latex present in the puncture sealing agent to the amount of the carbohydrate in the puncture sealing agent being within the ranges described above, the effects of the present invention can be better achieved.

The weight ratio of the solid content resulting from the rubber latex in the puncture sealing agent to the content of the carbohydrate in the puncture sealing agent is preferably at least 1:2, more preferably at least 1:1, even more preferably at least 2:1, and most preferably at least 4:1. Additionally, the weight ratio of the solid content resulting from the rubber latex in the puncture sealing agent to the content of the carbohydrate in the puncture sealing agent is preferably 25:1 or less, more preferably 10:1 or less, even more preferably 8:1 or less, and most preferably 6:1 or less. It is to be understood that the weight ratio of the solid content resulting from the rubber latex in the puncture sealing agent to the content of the carbohydrate in the puncture sealing agent is preferably in the range of 1:2 to 25:1, more preferably in the range of 1:1 to 10:1, even more preferably in the range of 2:1 to 8:1, and most preferably in the range of 4:1 to 6:1. However, also ranges of 1:2 to 10:1, 1:1 to 25:1, 4:1 to 10:1, as well as other ranges resulting from other combinations of the upper and lower limits mentioned above constitute preferred embodiments of the present invention. With the weight ratio of the solid content resulting from the rubber latex in the puncture sealing agent to the content of the carbohydrate in the puncture sealing agent being within the ranges described above, the effects of the present invention can be better achieved.

Besides the rubber latex, the carbohydrate and the antifreeze agent, the puncture sealing agent of the present invention comprises one or more additional polymers. Preferably, said one or more additional polymers are one or more polysaccharides which are different from the carbohydrate. More preferably, said one or more polysaccharides which are different from the carbohydrate are selected from cellulose, cellulose derivatives, chitin, chitosan, starch, starch derivatives, and mixtures thereof. Even more preferably, said one or more polysaccharides which are different from the carbohydrate are selected from cellulose, cellulose derivatives and mixtures thereof, with cellulose derivatives being most preferred among these.

When the polysaccharide which is different from the carbohydrate is a cellulose derivative, it is preferable that said cellulose derivative is a degraded cellulose, a cellulose ester, a cellulose ether, an oxidized cellulose, or any combination thereof. Examples of said degraded cellulose include, but are not limited to, microcrystalline cellulose, cellulose nanocrystals, microfibrillated cellulose, and combinations thereof. Examples of said cellulose ether include, but are not limited to, carboxymethyl cellulose and salts thereof, carboxymethyl hydroxyethyl cellulose and salts thereof, carboxymethyl hydroxypropyl cellulose and salts thereof, carboxymethyl sulfoethyl cellulose and salts thereof, carboxymethyl sulfopropyl cellulose and salts thereof, methylol cellulose, hydroxyethyl cellulose, hydroxyethyl methyl cellulose, hydroxyethyl ethyl cellulose, hydroxyethyl sulfoethyl cellulose and salts thereof, hydroxypropyl cellulose, hydroxypropyl methyl cellulose, hydroxypropyl ethyl cellulose, hydroxypropyl sulfoethyl cellulose and salts thereof, sulfoethyl cellulose and salts thereof, sulfopropyl cellulose, or any combination thereof. More preferably, the cellulose derivative is microcrystalline cellulose, cellulose nanocrystals, a cellulose ether which contains a hydroxyalkyl ether moiety, or a combination thereof. Even more preferably, the cellulose derivative is microcrystalline cellulose, a cellulose ether which contains a hydroxyethyl ether moiety and/or a hydroxypropyl moiety, or any combination thereof. Most preferably, the cellulose derivative is microcrystalline cellulose, hydroxyethyl methyl cellulose, or a combination thereof.

The puncture sealing agent of the present invention preferably comprises the one or more additional polymers in an amount of at least 0.05% by weight, more preferably at least 0.10% by weight, even more preferably at least 0.20% by weight, and most preferably at least 0.30% by weight, based on the total weight of the puncture sealing agent. Furthermore, the puncture sealing agent of the present invention preferably comprises the additional polymer in an amount of 5.0% by weight or less, more preferably 2.5% by weight or less, even more preferably 1.0% by weight or less, most preferably 0.50% by weight or less. It is to be understood that the amount of the one or more additional polymers contained in the puncture sealing agent is preferably in the range of 0.05% to 5.0% by weight, more preferably in the range of 0.10% to 2.5% by weight, even more preferably in the range of 0.20% to 1.0% by weight, and most preferably in the range of 0.30% to 0.50% by weight, based on the total weight of the puncture sealing agent. However, also ranges of 0.05% to 2.5% by weight, 0.10 to 5.0% by weight, 0.30% to 2.5% by weight, as well as other ranges resulting from other combinations of the upper and lower limits mentioned above constitute preferred embodiments of the present invention. With the content of the one or more additional polymers being within the ranges described above, the effects of the present invention can be better achieved. Where more than one additional polymer is contained in the puncture sealing agent, the weight percentages mentioned herein are to be understood as referring to the combined weight of the one or more additional polymers.

In view of enhanced sealing performance, especially when the puncture sealing agent is to be used in tubeless tires, it is preferred that the additional polymer is water-soluble, or, if the puncture sealing contains more than one additional polymer, that at least one of the additional polymers is water-soluble. As defined further below, in the context of the present application, “water-soluble” is to be understood as meaning “having a solubility of 1 g/L or more at 20° C.”. More preferably, the water-soluble additional polymer is a water-soluble polysaccharide. Examples of water-soluble polysaccharides include, but are not limited to, water-soluble starch derivatives and water-soluble cellulose derivatives. Even more preferably, the water-soluble polysaccharide is a water-soluble cellulose derivative. Most preferably, the water-soluble cellulose derivative is a water-soluble cellulose ether, with hydroxyalkyl cellulose ethers being particularly preferred.

When the puncture sealing agent comprises a water-soluble additional polymer, it is further preferable that the water-soluble additional polymer has a water solubility of at least 2 g/L at 20° C., more preferably at least 5 g/L at 20° C., even more preferably at least 10 g/L at 20° C., and most preferably at least 15 g/L at 20° C., with a solubility of at least 20 g/L at 20° C. being particularly preferred, wherein the solubility is determined according to the OECD Guidelines for Testing of Chemicals, Section 1, Test Guideline No. 105: Water Solubility, adopted on Jul. 27, 1995.

Besides the rubber latex, the carbohydrate and the additional polymer, the puncture sealing agent of the present invention comprises an antifreeze agent. Preferably, said antifreeze agent is an organic liquid, such as an alcohol, an ether or a mixture thereof. More preferably, the antifreeze agent is a polyhydric alcohol. Examples of said polyhydric alcohols include, but are not limited to, divalent alcohols (diols), trivalent alcohols (triols), and mixtures thereof. Even more preferably, the antifreeze agent is 1,2-propanediol, 1,3-propanediol, ethane-1,2-diol, glycerol, or a mixture thereof. Most preferably, the antifreeze agent is glycerol, which is nontoxic and constitutes an important biomass derivative obtained as a by-product in the manufacture of biodiesel. Hence, the use of glycerol as the antifreeze agent facilitates the preparation of a biomass-derived, resource-saving and environmentally friendly puncture sealing agent which can be stored and handled safely.

The puncture sealing agent of the present invention preferably comprises the antifreeze agent in an amount of at least 10% by weight, more preferably at least 15% by weight, even more preferably at least 20% by weight, and most preferably at least 25% by weight, based on the total weight of the puncture sealing agent.

Furthermore, the puncture sealing agent of the present invention preferably comprises the antifreeze agent in an amount of 50% by weight or less, more preferably 45% by weight or less, even more preferably 40% by weight or less, most preferably 35% by weight or less. It is to be understood that the amount of the antifreeze agent contained in the puncture sealing agent is preferably in the range of 10% to 50% by weight, more preferably in the range of 15% to 45% by weight, even more preferably in the range of 20% to 40% by weight, and most preferably in the range of 25% to 35% by weight, based on the total weight of the puncture sealing agent. However, also ranges of 10% to 45% by weight, 15 to 50% by weight, 25% to 45% by weight, as well as other ranges resulting from other combinations of the upper and lower limits mentioned above constitute preferred embodiments of the present invention. With the content of the antifreeze agent being within the ranges described above, the effects of the present invention can be better achieved.

From an ecological point of view, it is preferred that in the puncture sealing agent the rubber latex, the carbohydrate, the one or more additional polymers and the antifreeze agent are natural components. In this regard, the combined content of all natural components of the puncture sealing agent is more preferably equal to or greater than 90% by weight, even more preferably 95% by weight, based on the total mass of the puncture sealing agent. Most preferably, the puncture sealing agent is free from any synthetic resins. The low content or preferably absence of synthetic resin in the puncture sealing agent allows for a resource saving and environmentally friendly puncture sealing agent which can be easily used and disposed of. In the context of this application, the term natural component refers to compounds and derivatives of compounds that can be found in nature and are not petroleum derived, i.e. the term includes compounds that can be found in nature but which have been modified for example by a chemical reaction. Usually, synthetic resins are petroleum derived resins.

In view of ensuring sufficient viscosity and improving sealing performance, in particular in tires having an inner tube, the puncture sealing agent of the present invention may further comprise a biomass-derived polymeric material which is different from the additional polymer, the carbohydrate and the rubber latex. Examples of the biomass-derived polymeric material include, but are not limited to, polymeric materials obtained from plants, algae, bacteria, or arthropods, such as crustacea or insects, wherein the polymeric material may include, but is not limited to, cellulose, cellulose derivatives, lignin, lignocellulose, starch, starch derivatives, chitin, chitosan, suberin, and mixtures thereof. Preferably, the biomass-derived polymeric material is a plant-derived polymeric material. For example, the plant-derived polymeric material may be derived from cotton, hemp, flax, jute, grasses or straw, from agricultural waste, such as residues of sugar cane, corn, rice, soybean, sunflower or castor bean plants, or from woody plants such as trees or shrubs, but without being limited to the aforementioned sources. More preferably, the biomass-derived polymeric material is derived from plants and contains cellulose, a cellulose derivative, lignin, lignocellulose, suberin, or a combination thereof. Even more preferably, the plant-derived polymeric material contains cellulose, a cellulose derivative, lignin, lignocellulose, suberin, or a combination thereof and is derived from woody plants. For example, the polymeric material derived from woody plants may be derived from the wood, bark, roots, branches or foliage (i.e., leaves or needles) of trees or shrubs. Most preferably, the biomass-derived polymeric material is derived from woody plants and is selected from the group consisting of cork powder, wood flour, lignin, lignocellulose, cellulose, water-insoluble cellulose derivatives, and mixtures of one or more thereof. Among these, cork powder, lignin, cellulose, and mixtures thereof are particularly preferred.

In view of ensuring sufficient viscosity and improving sealing performance, in particular in tires having an inner tube, it is preferred that at least one of the additional polymer and (if present) the biomass-derived polymeric material is a water-insoluble material. More preferably, the biomass-derived polymeric material is water-insoluble. In the context of the present application, a water-soluble material is to be understood as a material which, at 20° C., has a solubility in water of 1 g/L or more, as determined according to the OECD Guidelines for Testing of Chemicals, Section 1, Test Guideline No. 105: Water Solubility, adopted on Jul. 27, 1995. In the context of the present application, a water-insoluble material is therefore to be understood as a material which, at 20° C., has a solubility in water of less than 1 g/L, as determined according to the OECD Guidelines for Testing of Chemicals, Section 1, Test Guideline No. 105: Water Solubility, adopted on Jul. 27, 1995. Even more preferably, the biomass-derived polymeric material is a water-insoluble, plant-derived polymeric material. Most preferably, the biomass-derived polymeric material is a water-insoluble, plant-derived polymeric material which contains cellulose, a cellulose derivative, lignin, lignocellulose, suberin, or a combination thereof. Among these, cork powder, wood flour, lignin, lignocellulose, cellulose, water-insoluble cellulose derivatives, and mixtures of one or more thereof, are particularly preferred.

If the puncture sealing agent comprises a biomass-derived polymeric material which is different from the additional polymer, the carbohydrate and the rubber latex, the puncture sealing agent of the present invention preferably comprises said biomass-derived polymeric material in an amount of at least 0.1% by weight, more preferably at least 0.25% by weight, even more preferably at least 0.5% by weight, and most preferably at least 1% by weight, based on the total weight of the puncture sealing agent. Furthermore, the puncture sealing agent of the present invention preferably comprises the biomass-derived polymeric material in an amount of 10% by weight or less, more preferably 5% by weight or less, even more preferably 3% by weight or less, most preferably 2% by weight or less. It is to be understood that the amount of the biomass-derived polymeric material contained in the puncture sealing agent is preferably in the range of 0.1% to 10% by weight, more preferably in the range of 0.25% to 5% by weight, even more preferably in the range of 0.5% to 3% by weight, and most preferably in the range of 1% to 2% by weight, based on the total weight of the puncture sealing agent. However, also ranges of 0.1% to 5% by weight, 0.25 to 10% by weight, 1% to 5% by weight, as well as other ranges resulting from other combinations of the upper and lower limits mentioned above constitute preferred embodiments of the present invention. With the content of the biomass-derived polymeric material being within the ranges described above, the effects of good sealing performance and sufficient viscosity can be better achieved.

The weight ratio of the amount of biomass-derived polymeric material present in the puncture sealing agent to the amount of the additional polymer in the puncture sealing agent is preferably at least 1:10, more preferably at least 1:5, even more preferably at least 1:1, and most preferably at least 2:1. Additionally, the weight ratio of the amount of the biomass-derived polymeric material present in the puncture sealing agent to the amount of the additional polymer in the puncture sealing agent is preferably 25:1 or less, more preferably 10:1 or less, even more preferably 5:1 or less, and most preferably 4:1 or less. It is to be understood that the weight ratio of the amount of the biomass-derived polymeric material present in the puncture sealing agent to the amount of the additional polymer in the puncture sealing agent is preferably in the range of 1:10 to 25:1, more preferably in the range of 1:5 to 10:1, even more preferably in the range of 1:1 to 5:1, and most preferably in the range of 2:1 to 4:1. However, also ranges of 1:10 to 10:1, 1:5 to 25:1, 2:1 to 10:1, as well as other ranges resulting from other combinations of the upper and lower limits mentioned above constitute preferred embodiments of the present invention. With the weight ratio of the amount of the biomass-derived polymeric material present in the puncture sealing agent to the amount of the additional polymer in the puncture sealing agent being within the ranges described above, the effects of good sealing performance and sufficient viscosity can be better achieved.

Especially when the puncture sealing agent is to be used in tires having an inner tube, it is therefore preferred that a water-soluble additional polymer is combined with a water-insoluble, biomass-derived polymeric material, and/or that a water-soluble additional polymer is combined with a water-insoluble additional polymer. More preferably, a water-soluble polysaccharide is combined with a water-insoluble, plant-derived polymeric material, and/or a water-soluble polysaccharide is combined with a water-insoluble polysaccharide. Even more preferably, a water-soluble cellulose derivative, a water-soluble starch derivative or a mixture thereof is combined with a water-insoluble, plant-derived polymeric material which contains cellulose, a cellulose derivative, lignin, lignocellulose, suberin, or a mixture thereof, and/or a water-soluble cellulose derivative, a water-soluble starch derivative or a mixture thereof is combined with cellulose, a water-insoluble cellulose derivative, starch, a water-insoluble starch derivative or a mixture thereof. Most preferably, a water-soluble cellulose derivative is combined with a water-insoluble, plant-derived polymeric material selected from cork powder, wood flour, lignin, lignocellulose, cellulose, water-insoluble cellulose derivatives, and mixtures thereof.

When a water-soluble additional polymer is combined with a water-insoluble, biomass-derived polymeric material, or when a water-soluble additional polymer is combined with a water-insoluble additional polymer, the weight ratio of the water-insoluble additional polymer and/or water-insoluble biomass-derived polymeric material in the puncture sealing agent to the amount of water-soluble additional polymer present in the puncture sealing agent is preferably at least 1:10, more preferably at least 1:5, even more preferably at least 1:1, and most preferably at least 2:1. Additionally, the weight ratio of the water-insoluble additional polymer and/or water-insoluble biomass-derived polymeric material in the puncture sealing agent to the amount of water-soluble additional polymer present in the puncture sealing agent is preferably 25:1 or less, more preferably 10:1 or less, even more preferably 5:1 or less, and most preferably 4:1 or less. It is to be understood that the weight ratio of the water-insoluble additional polymer and/or water-insoluble biomass-derived polymeric material in the puncture sealing agent to the amount of water-soluble additional polymer present in the puncture sealing agent is preferably in the range of 1:10 to 25:1, more preferably in the range of 1:5 to 10:1, even more preferably in the range of 1:1 to 5:1, and most preferably in the range of 2:1 to 4:1. However, also ranges of 1:10 to 10:1, 1:5 to 25:1, 2:1 to 10:1, as well as other ranges resulting from other combinations of the upper and lower limits mentioned above constitute preferred embodiments of the present invention. With the weight ratio of the water-insoluble additional polymer and/or water-insoluble biomass-derived polymeric material in the puncture sealing agent to the amount of water-soluble additional polymer present in the puncture sealing agent being within the ranges described above, the effects of good sealing performance and sufficient viscosity can be better achieved. The expression “amount of the water-insoluble additional polymer and/or water-insoluble biomass-derived polymeric material in the puncture sealing agent” as used above refers to the combined amounts of water-insoluble additional polymers and water-insoluble biomass-derived polymeric materials if both types are present in the puncture sealing agent. In cases where the puncture sealing composition comprises more than one water-soluble additional polymer, the expression “amount of the water-soluble additional polymer” as used above refers to the combined amounts of the one or more water-soluble additional polymers.

Optionally, the puncture sealing agent may comprise a surfactant, preferably in an amount which is equal to or less than 0.5% by weight, and more preferably equal to or less than 0.3% by weight, based on the total weight of the puncture sealing agent. The surfactant improves the storage stability of the puncture sealing agent, since it prevents unwanted coagulation of rubber particles during storage. If more than 0.5% by weight of surfactant is used, there is a risk that the sealing performance is deteriorated. The presence of a surfactant is not essential, however. The puncture sealing agent of the present invention may also be free of surfactants.

If the puncture sealing agent comprises a surfactant, it is particularly preferred that the surfactant is a natural compound, i.e. not petroleum based. If the surfactant is a natural compound, the puncture sealing agent is resource saving and environmentally friendly. Natural surfactants can be anionic surfactants, amphoteric surfactants, cationic surfactants, non-ionic surfactants or mixtures thereof. Most preferably, the natural surfactant comprises at least one non-ionic surfactant.

Anionic surfactants have a negatively charged hydrophilic head and examples of anionic surfactants are sodium sulfates, ammonium sulfates, sulfosuccinates, sarcosines, sarcosinates, isethionates, taurates, alkylbenzene sulfonates, alkyl phosphates, and alkenyl succinates. Amphoteric surfactants have either a positive or negative charge, depending on the pH of the medium. Some examples for amphoteric surfactants are coco betaine, lauryl betaine, hydroxysultaines, alkyl dimethyl betaine and alkyl amide betaine. Cationic surfactants present a positively charged head at the hydrophilic part. Examples for cationic surfactants include chlorides of benzalkonium, stearalkonium, centrimonium and trimethyl ammonium compounds, methyl sulfates, alkylamine acetates, and quaternary ammonium salts. Nonionic surfactants have no ionic charge in their hydrophilic units. Some examples for nonionic surfactants include ethoxylates oxides, wax, emulsifying wax, glyceryl oleate, glyceryl stearate, PEGylated compounds such as ceteareths and sorbitans, lauryl glucoside, polyglycose, polyoxyethylene alcohol ethers, polyoxyethylene fatty acid esters, polyoxyethylene alkylphenols, and polyoxyethylene-polyoxypropylene block polymers.

Optionally, the puncture sealing agent may also comprise one or more colouring agents, e.g. to improve its visibility and aesthetic appearance, or to facilitate distinction from other products. If the puncture sealing agent comprises a colouring agent, the colouring agent is preferably a natural compound. More preferably, the colouring agent is a non-toxic natural compound. The one or more non-toxic natural colouring agents may include natural organic compounds as well as inorganic pigments derived from naturally occurring minerals. Examples of non-toxic natural organic colouring agents which may be present in the puncture sealing agent include, but are not limited to, anthocyanins (E163), betanin (E162), canthaxanthin (E161g), carotene (E160a), bixin/norbixin (E160b), capsanthin (E160c), lycopene (E160d), apocarotenal (E160e), chlorophyll (E140), chlorophyllin (E141), curcumin (E100), carmine (E120), lutein (E161b), riboflavin (E101), and combinations thereof. Examples of non-toxic inorganic pigments include, but are not limited to, iron oxide pigments, zinc pigments such as zinc white and zinc ferrite, titanium pigments such as titanium white, and combinations thereof. Even more preferably, the colouring agent is a non-toxic natural organic compound because, in this case, the colouring agent is obtainable entirely from renewable sources and may have better solubility in the puncture sealing agent. Herein, the amount of the colouring agent(s) in the puncture sealing agent is not particularly limited, and may be freely adjusted by the skilled person until the desired coloration is achieved.

In the context of the present application, the term “non-toxic” is to be understood as meaning “not classified within any of the four acute toxicity hazard categories I to IV of the Globally Harmonized System of Classification and Labelling of Chemicals (GHS), Eighth Revised Edition, United Nations 2019, due to having, or being anticipated to have, an oral or dermal LD₅₀ in test animals of at least 2000 mg/kg of body weight.”

It is noted that the above described features of the puncture sealing agent can of course be combined with each other to give preferred embodiments of the invention. Accordingly, in preferred embodiments of the invention, the compounds and the value ranges for the compounds described above are independently chosen and combined with each other. This results in a large number of possible embodiments representing the invention, only a few of which are explicitly mentioned. The skilled person understands that it is possible to combine the subsequently mentioned preferred embodiments with each other and with the features described above.

Accordingly, one preferred exemplary embodiment of the puncture sealing agent, based on the total weight of the puncture sealing agent, comprises 0.1 to 15% by weight of the carbohydrate, 5 to 45% by weight of the rubber latex, 0.05 to 5.00% by weight of the additional polymer and 10 to 50% by weight of the antifreeze agent, wherein the rubber latex is a natural rubber latex having a solid content of 30 to 80% by weight, based on 100% by weight of the natural rubber latex, and wherein the additional polymer is a polysaccharide which is different from the carbohydrate.

In another preferred exemplary embodiment, the carbohydrate is selected from the group consisting of sucrose, glucose, fructose and mixtures of two or more of these carbohydrates and the antifreeze agent is at least one selected from the group consisting of glycerol, ethylene glycol, propane-1,2-diol, propane-1,3-diol and mixtures thereof.

According to a further preferred exemplary embodiment, the puncture sealing agent comprises, based on 100% by weight of the puncture sealing agent, natural rubber latex in such an amount that the solid content in the puncture sealing agent which is derived from the natural rubber latex is 20% by weight or less, and 1.0% by weight or less of an additional polymer, wherein the additional polymer is at least one polysaccharide which is different from the carbohydrate, preferably cellulose or a cellulose derivative.

According to a further preferred exemplary embodiment, in the puncture sealing agent, based on 100% by weight of the puncture sealing agent, the amount of natural rubber latex is such that in the puncture sealing agent the solid content derived from natural rubber is 17.5% by weight or less, and, also based on 100% by weight of the puncture sealing agent, the amount of carbohydrate is 2% by weight or more, wherein it is even more preferable that the carbohydrate is a monosaccharide, a disaccharide, an oligosaccharide or a mixture thereof, and further preferably, the carbohydrate is selected from the group consisting of sugars and degraded starches.

In another preferred exemplary embodiment, in the puncture sealing agent, based on 100% by weight of the puncture sealing agent, the amount of carbohydrate is 2% by weight or more and the carbohydrate is a disaccharide or an oligosaccharide, in particular a disaccharide, for example sucrose.

According to a further preferred exemplary embodiment, the puncture sealing agent comprises, based on 100% by weight of the puncture sealing agent, natural rubber latex in an amount, such that the solid content in the puncture sealing agent which is derived from the natural rubber latex is in the range of 10 to 20% by weight, and the carbohydrate is at least one having a solubility in water of 100 g/L or more at a temperature of 20° C.

In a further preferred exemplary embodiment, the puncture sealing agent comprises the antifreeze agent, based on 100% by weight of the puncture sealing agent, in an amount of 25t % by weight or more, wherein the antifreeze agent is at least one of ethylene glycol, propylene glycol, propane-1,3-diol and glycerol, and wherein the carbohydrate is at least one of sucrose, fructose and dextrin.

According to another preferred exemplary embodiment, the additional polymer is one or more polysaccharides which are different from the carbohydrate, the additional polymer being present in an amount of 0.05% by weight or more per 100% by weight of the puncture sealing agent, the rubber latex is ammonia-free natural rubber latex which is present in an amount of 20% by weight or more per 100% by weight of the puncture sealing agent and preferably has a solid content of 50% by weight or more per 100% by weight of the ammonia-free natural rubber latex, the antifreeze agent is glycerol which is present in amount of 20 to 45% by weight per 100% by weight of the puncture sealing agent, and the carbohydrate is fructose, glucose or sucrose, the carbohydrate being present in an amount of 2 to 10% by weight per 100% by weight of the puncture sealing agent.

According to another preferred exemplary embodiment, the additional polymer is one or more polysaccharides which are different from the carbohydrate and which are selected from cellulose, cellulose derivatives, chitin, chitosan, starch, starch derivatives, and mixtures thereof, the additional polymer being present in an amount of 0.10 to 5% by weight per 100% by weight of the puncture sealing agent, the rubber latex is a natural rubber latex being present in an amount of 15 to 35% by weight per 100% by weight of the puncture sealing agent and preferably has a solid content of at least 40% by weight per 100% by weight of the natural rubber latex, the carbohydrate is selected from fructose, galactose, glucose, mannose, xylose, sucrose, cellobiose, lactose, maltose, sucrose, trehalose, glucose syrup, glucose-fructose syrup, or mixtures thereof, the carbohydrate being present in an amount of 1 to 15% by weight per 100% by weight of the puncture sealing agent, and the antifreeze agent is 1,2-propanediol, 1,3-propanediol, ethane-1,2-diol, glycerol, or a mixture thereof, the antifreeze agent being present in an amount of 10 to 50% by weight per 100% by weight of the puncture sealing agent.

According to another preferred exemplary embodiment, the additional polymer is one or more polysaccharides which are different from the carbohydrate, said one or more polysaccharides being one or more cellulose derivatives selected from microcrystalline cellulose, cellulose nanocrystals, cellulose esters, cellulose ethers and mixtures thereof, the additional polymer being present in an amount of 0.20 to 2.50% by weight per 100% by weight of the puncture sealing agent, the rubber latex is present in an amount of 10 to 40% by weight per 100% by weight of the puncture sealing agent, the carbohydrate is one or more selected from sugars and hydrolysates of starch and is present in an amount of 0.5% by weight or more per 100% by weight of the puncture sealing agent, and the antifreeze agent is selected from divalent alcohols, trivalent alcohols and mixtures thereof, the antifreeze agent being present in an amount of at least 10% by weight per 100% by weight of the puncture sealing agent.

According to another preferred exemplary embodiment, the additional polymer is one or more polysaccharides which are different from the carbohydrate, said one or more polysaccharides being selected from microcrystalline cellulose, cellulose ethers comprising a hydroxyethyl group, cellulose ethers comprising a hydroxypropyl group, and mixtures thereof, the additional polymer being present in an amount of 0.30 to 2.50% by weight per 100% by weight of the puncture sealing agent, the rubber latex is present in amount of 10% by weight or more per 100% by weight of the puncture sealing agent, the carbohydrate is one or more selected from monosaccharides, disaccharides, and oligosaccharides, the carbohydrate being present in an amount of 0.1% by weight or more per 100% by weight of the puncture sealing agent, and the antifreeze agent is selected from one or more alcohols, one or more ethers, and mixtures thereof, the antifreeze agent being present in an amount of 50% by weight or less per 100% by weight of the puncture sealing agent.

According to yet another preferred exemplary embodiment, the puncture sealing agent comprises a water-soluble hydroxyalkyl cellulose ether in an amount of at least 0.2 weight-% per 100 weight-% of the puncture sealing agent, and a water-insoluble biomass-derived polymeric material containing cellulose, a cellulose derivative, lignin, lignocellulose, starch, a starch derivative, chitin, chitosan, suberin, or a mixture thereof, the water-insoluble, biomass-derived polymeric material being present in an amount of at least 0.5 weight-% per 100 weight-% of the puncture sealing agent.

According to yet another preferred exemplary embodiment, the puncture sealing agent comprises a water-soluble cellulose ether which has a water solubility of at least 5 g/L at 20° C. and is present in an amount of 0.1 to 2.5 weight-% per 100 weight-% of the puncture sealing agent, a water-insoluble, plant-derived polymeric material containing cellulose, a cellulose derivative, lignin, lignocellulose, suberin, or a combination thereof, in an amount of 0.25 to 5.0 weight-% per 100 weight-% of the puncture sealing agent, and an optional coloring agent.

According to yet another preferred exemplary embodiment, the puncture sealing agent comprises a water-soluble polysaccharide in an amount of at least 0.05 weight-% per 100 weight-% of the puncture sealing agent, a water-insoluble polymeric material which is derived from woody plants and is selected from cork powder, wood flour, lignin, lignocellulose, cellulose, water-insoluble cellulose derivatives, and mixtures thereof, in an amount of at least 0.1 weight-% per 100 weight-% of the puncture sealing agent, and optionally, a coloring agent selected from natural organic compounds and natural inorganic pigments.

According to yet another preferred exemplary embodiment, the rubber latex is natural rubber latex and is present in an amount of 5 to 45% by weight per 100% by weight of the puncture sealing agent, the carbohydrate is selected from monosaccharides, disaccharides, oligosaccharides and mixtures thereof and is present in an amount of 0.1 to 15% by weight per 100% by weight of the puncture sealing agent, the additional polymer is a water-soluble polysaccharide which is present in an amount of 0.05 to 5.00% by weight per 100% by weight of the puncture sealing agent, the antifreeze agent is selected from one or more alcohols, one or more ethers, and mixtures thereof, and is present in an amount of 10 to 50% by weight per 100% by weight of the puncture sealing agent, and the puncture sealing agent additionally comprises a water-insoluble, plant-derived polymeric material which contains cellulose, a cellulose derivative, lignin, lignocellulose, suberin, or a combination thereof.

According to yet another preferred exemplary embodiment, the rubber latex is a natural rubber latex, the solid content resulting from the natural rubber latex being between 5 and 25 weight-% per 100 weight-% of the puncture sealing agent, the carbohydrate is a monosaccharide or disaccharide, has a water solubility at 20° C. of 300 g/L or more and is present in an amount of 1 weight-% or more per 100 weight-% of the puncture sealing agent, the additional polymer is a water-soluble cellulose derivative which is present in an amount of 0.10 to 2.50 weight-% per 100 weight-% of the puncture sealing agent and has a water solubility of at least 5 g/L at 20° C., the antifreeze agent is a polyhydric alcohol which is present in an amount of 15 to 45 weight-% per 100 weight-% of the puncture sealing agent, and the puncture sealing agent further comprises a water-insoluble, plant-derived polymeric material selected from cork powder, wood flour, lignin, lignocellulose, cellulose, water-insoluble cellulose derivatives, and mixtures thereof, wherein the puncture sealing agent optionally comprises a natural, non-toxic coloring agent.

According to yet another preferred exemplary embodiment, the rubber latex is ammonia-free natural rubber latex which is present in an amount of 15 to 35 weight-% per 100 weight-% of the puncture sealing agent, the solid content resulting from the natural rubber latex being 10 weight-% or more per 100 weight-% of the puncture sealing agent, the carbohydrate is selected from dextrin, glucose syrup, glucose-fructose syrup, fructose, glucose, lactose, maltose, sucrose and mixtures thereof and is present in an amount of 2 weight-% or more per 100 weight-% of the puncture sealing agent, the antifreeze agent is selected from 1,2-propanediol, 1,3-propanediol, ethane-1,2-diol, glycerol or a mixture thereof and is present in an amount of 15 to 45 weight-% per 100 weight-% of the puncture sealing agent, the additional polymer is a water-soluble cellulose ether which has a water solubility of at least 10 g/L at 20° C. and is present in an amount of at least 0.10 weight-% per 100 weight-% of the puncture sealing agent, and the puncture sealing agent further comprises a water-insoluble biomass-derived polymeric material containing cellulose, a cellulose derivative, lignin, lignocellulose, starch, a starch derivative, chitin, chitosan, suberin, or a mixture thereof, the water-insoluble, biomass-derived polymeric material being present in an amount of at least 0.25 weight-% per 100 weight-% of the puncture sealing agent.

The puncture sealing agent according to the present invention can be used for repairing and/or preventing punctures in tires equipped with a Schrader valve, a Sclaverand valve (also known as Presta valve), or a Dunlop valve.

The puncture sealing agent according to the present invention can be used for repairing and/or preventing punctures in tubeless tires and in tires having an inner tube, wherein the tubeless tires and the tires having an inner tube are preferably tires for bicycles, bicycle trailers, electric scooters, hand trucks or wheelbarrows, more preferably for bicycles and electric scooters. Particularly preferred examples of the bicycles include electric bicycles, children's bicycles, cargo bicycles, and mountain bikes.

According to a preferred exemplary embodiment, the puncture sealing agent of the present invention is used for repairing and/or preventing punctures in a tubeless bicycle tire, preferably in a tubeless children's bicycle tire, a tubeless electric bicycle tire, a tubeless cargo bicycle tire or a tubeless mountain bike tire, more preferably in a tubeless electric bicycle tire.

According to another preferred exemplary embodiment, the puncture sealing agent of the present invention is used for repairing and/or preventing punctures in a bicycle tire having an inner tube, wherein the bicycle tire having an inner tube is preferably a children's bicycle tire, an electric bicycle tire, a cargo bicycle tire or a mountain bike tire, more preferably an electric bicycle tire.

According to a further preferred exemplary embodiment, the puncture sealing agent of the present invention is used for repairing and/or preventing punctures in a tubeless e-scooter tire.

According to a further preferred exemplary embodiment, the puncture sealing agent of the present invention is used for repairing and/or preventing punctures in an e-scooter tire having an inner tube.

According to yet another preferred exemplary embodiment, the puncture sealing agent of the present invention is used for repairing punctured tubeless e-scooter tires, tubeless electric bicycle tires, tubeless cargo bicycle tires, or tubeless mountain bike tires, preferably punctured tubeless e-scooter tires, tubeless electric bicycle tires, or tubeless mountain bike tires, more preferably punctured tubeless e-scooter tires or tubeless electric bicycle tires, even more preferably punctured tubeless electric bicycle tires.

According to yet another preferred exemplary embodiment, the puncture sealing agent of the present invention is used for repairing punctured tires having an inner tube, wherein said punctured tires having an inner tube are e-scooter tires, electric bicycle tires, cargo bicycle tires, mountain bike tires or children's bicycle tires, preferably e-scooter tires, electric bicycle tires or mountain bike tires, more preferably e-scooter tires or electric bicycle tires, even more preferably electric bicycle tires.

According to yet another preferred exemplary embodiment, the puncture sealing agent of the present invention is used for preventing punctures in tubeless e-scooter tires, tubeless electric bicycle tires, tubeless cargo bicycle tires, or tubeless mountain bike tires, preferably in tubeless e-scooter tires, tubeless electric bicycle tires, or tubeless mountain bike tires, more preferably in tubeless e-scooter tires or tubeless electric bicycle tires, even more preferably in tubeless electric bicycle tires.

According to yet another preferred exemplary embodiment, the puncture sealing agent of the present invention is used for preventing punctures in tires having an inner tube, wherein said tires having an inner tube are e-scooter tires, electric bicycle tires, cargo bicycle tires, mountain bike tires or children's bicycle tires, preferably e-scooter tires, electric bicycle tires or mountain bike tires, more preferably e-scooter tires or electric bicycle tires, even more preferably electric bicycle tires.

TABLE 1
Puncture sealing compositions according to Examples 1, 4 and 5

Amount (weight-%)

| Component | Ex. 1 | Ex. 4 | Ex. 5* |
|---|---|---|---|
| Ammonia-free natural rubber | 25 | 25 | 25 |
| latex, 60% solid content | | | |
| Water | 46.54 | 45.04 | 46.94 |
| Sucrose | 3.06 | 3.06 | 3.06 |
| Hydroxyethyl methyl cellulose | 0.40 | 0.40 | — |
| (Tylose MH, CAS 9032-42-2) | | | |
| Cork powder | — | 1.5 | — |
| Glycerol | 25 | 25 | 25 |
| Color (Chlorophyllin, E140) | Green | Green | Green |

*Example 5 is not according to the invention.

### EXAMPLE 1

A puncture sealing agent according to the present invention was prepared by mixing a rubber latex (ammonia-free natural rubber latex), a carbohydrate (sucrose), an additional polymer (hydroxyethyl methyl cellulose), an antifreeze agent (glycerol) water and a coloring agent (chlorophyllin) according to the formulation given in Table 1 above.

In order to check the injectability of the above formulation, it was injected into a tubeless bicycle tire through the valve of the tire at varying temperatures with the aid of a manually operated bicycle air pump, without using a compressor. It was found that, over a temperature range from −20° C. to +50° C., the material could be injected into the tire without clogging the valve.

To test the sealing performance of the above composition in an emergency situation, a puncture tool was used to create a hole having a diameter of 4 mm in the tread portion of a tubeless bicycle tire. After pulling out the puncture tool, the puncture sealing agent according to the formulation above was injected through the tire valve using a manually operated bicycle air pump, and driving was simulated by spinning the wheel. After one minute of spinning, there was no more air leakage and the tire presented a tight status, i.e. no bubbling effect was observed after spraying water in the vicinity of the puncture hole.

To test the sealing performance of the above composition when it is used preventively, the formulation was injected into a tubeless bicycle tire through an air valve while the tire was still intact, using a manually operated bicycle air pump. Then, a puncture tool was used to create a hole having a diameter of 4 mm in the tread portion of the tire. After pulling out the puncture tool, driving was simulated by spinning the wheel. After one minute of spinning, there was no more air leakage and the tire presented a tight status, i.e. no bubbling effect was observed after spraying water in the vicinity of the puncture hole. Re-pumping of the tire was not required.

The composition was then subjected to sealing performance tests in a bicycle tire having an inner tube. To test the sealing performance in tires having an inner tube in an emergency situation, a puncture tool was used to create holes in two inner tubes for bicycle tires, one hole having a diameter of 2 mm and being situated in the tread portion of one inner tube, and the other hole having a diameter of 2 mm and being situated in the side section of another inner tube. After pulling out the puncture tool and placing each tube within a tire and on a wheel, the puncture sealing agent according to the formulation above was injected through the tire valve using a manually operated bicycle air pump, and driving was simulated by spinning the wheel. As shown in Table 2, the puncture holes were sealed within ten minutes of spinning.

To test the sealing performance of the above composition when it is used preventively in a tire with an inner tube, the formulation was injected into two tires having an inner tube through an air valve while the tires and inner tubes were still intact, using a manually operated bicycle air pump. Then, a puncture tool was used to create holes in the two bicycle tires, one hole having a diameter of 2 mm and being situated in the tread portion of one tire, and the other hole having a diameter of 2 mm and being situated in the side section of the other tire. After pulling out the puncture tool, driving was simulated by spinning the wheel. As shown in Table 2, the puncture holes were sealed within ten minutes of spinning. Re-pumping of the tires was required.

To evaluate the storage properties, stability tests were performed causing the original state of the dispersion to change or at least to be stressed. The aging experiments with respect to preventive use were carried out as follows: The sealant was pumped inside an intact tire, as when used preventively. The tire together with the wheel rim and the sealant was then subjected to repeated +60/−25° C. cycles for 6 hours. Subsequently, the tire was stored for twenty days at room temperature (20° C.). Throughout this period, the sealing agent remained liquid and did not coagulate. Accordingly, it was found that the formulation can be stored between −25° C. and +60° C. With respect to emergency applications, the shelf-life of the above-described formulation when not removed from its original bottle was determined as follows: Aging tests were performed using a LUMiSizer (available from LUM GmbH, Berlin, Germany) by analyzing particle and droplet velocity distributions for creaming and sedimentation phenomena and determining particle size (in conformity with ISO 13318-2:2007). After running a simulation using the LUMiSizer, the shelf life of the sealant within the bottle was estimated to be six years (in conformity with ISO/TR 13097:2013). With respect to preventative applications, the period during which the formulation remains liquid when placed within the tire was estimated to be six months.

### EXAMPLE 2

A puncture sealing agent according to the present invention was prepared as described above in Example 1, except that hydroxy ethyl methyl cellulose was replaced with the same amount of microcrystalline cellulose (CAS 9004-34-6). Injectability, sealing performance and storage properties were evaluated using the same methods as described above in Example 1 and were found to be equal to those observed with the composition containing hydroxyethyl methyl cellulose.

### EXAMPLE 3

A puncture sealing agent according to the present invention was prepared as described above in Example 1, except that ammonia-free natural rubber latex was replaced with the same amount of a high-ammonia natural rubber latex (0.6% ammonia, approx. 60% solid content). Injectability, sealing performance and storage properties were evaluated using the same methods as described above in Example 1 and were found to be equal to those observed with the composition containing ammonia-free natural rubber latex.

### EXAMPLE 4

A puncture sealing agent according to the present invention was prepared by mixing a rubber latex (ammonia-free natural rubber latex), a carbohydrate (sucrose), an additional polymer (hydroxyethyl methyl cellulose), a biomass-derived polymeric material (cork powder), an antifreeze agent (glycerol), water and a coloring agent (chlorophyllin) according to the formulation given in Table 1 above. Sealing performance was evaluated using the same methods as described above in Example 1, except that the sealing agent was injected after removing the valve, and the results are shown in Table 2. The sealant does not come out of the tube, which results in two advantages: First, the hole is sealed fast, and secondly, no dirt is generated by sealant in the wheel rim or at the valve position.

### EXAMPLE 5

A comparative puncture sealing agent outside the scope of the present invention was prepared by mixing a rubber latex (ammonia-free natural rubber latex), a carbohydrate (sucrose), an antifreeze agent (glycerol), water and a coloring agent (chlorophyllin) according to the formulation given in Table 1 above. Injectability and sealing performance were evaluated using the same methods as described above in Example 1, and the results are shown in Table 2. This composition, which contained neither an additional polymer (such as cellulose) nor a biomass-derived polymeric material (such as cork powder), displayed poor aging properties as it coagulated within the tire during storage. No sealing effect at all was observed in tires with an inner tube. Sealing performance in tubeless tires was lower than in the examples containing the additional polymer and/or the biomass-derived polymeric material.

TABLE 2
Performance of sealing compositions
according to Examples 1, 4 and 5

| | Road Test | | | Aging⁽¹⁾ |
|---|---|---|---|---|
| | Tubeless | Tires with | Seal | Storage |
| Sealant | tires | inner tube | Retention | Properties |
| Tip Top⁽²⁾ | B | − | − | n.d. |
| milKit⁽²⁾ | A | B⁻ | + | n.d. |
| Slime⁽²⁾ | B | − | − | n.d. |
| Example 1 | AA | B⁻ | + | L |
| Example 4 | AA | AA | + | L |
| Example 5 | A | − | + | C |

⁽¹⁾Aging test conditions were as described above in Example 1, i.e. sealant was pumped inside an intact tire, and the tire together with the wheel rim and the sealant was subjected to repeated +60/−25° C. cycles for 6 hours. Subsequently, the tire was stored for twenty days at room temperature (20° C.).
⁽²⁾Commercial puncture sealing agents available from REMA TIP TOP AG, Poing, Germany (“Tip Top”), SPORT COMPONENTS AG, Zurich, Switzerland (“milKit”), and ITW Global Tire Repair Inc., San Luis Obispo, USA (“Slime”), respectively.
Legend:
−: Negative result.
AA: Sealed within the first minute of rotation. No repumping required.
A: Sealed within the first two minutes of rotation. No repumping required.
B: Sealed within the first five minutes of rotation. Repumping may be required.
B⁻: Sealed within the first ten minutes of rotation. Repumping is required.
L: Liquid.
C: Coagulated.
n.d. not determined.

TABLE 3
Physical properties of sealing compositions
according to Ex. 1 and 4

| | | Viscosity at 20° C. | Viscosity at −10° C. |
|---|---|---|---|
| Sealant | Density (g/mL) | (mPa · s) | (mPa · s) |
| Example 1 | 1.065 | 220 | 700 |
| Example 4 | 0.957 | 600 | 900 |

Viscosity was measured in accordance with DIN EN ISO 2555:2018 using a Brookfield viscosimeter with stainless steel spindle LV-3 at 20-60 rpm at 20° C. and at −10° C. The density was measured by using an areometer at 20° C. according to DIN 12791-1:2011-01.

Examples 1 to 4 show that an environmentally friendly, resource-saving puncture sealing agent based on natural compounds according to the present invention can be injected into tubeless tires over a broad temperature range from −20° C. to +50° C. to seal punctures having a size of up to 4 mm in both emergency and preventative applications. In each example, the puncture sealing agent can be injected using a manually operated air pump, such as a bicycle pump, without any need for a compressor, which is important in emergency situations. Moreover, the puncture sealing agent of Examples 1 to 4 is stable during storage, resulting in a long estimated shelf life of 6 years. Examples 1 and 3 demonstrate that ammonia-free and ammonia-containing natural rubber latex can be used interchangeably in the puncture sealing agent without negatively affecting performance. Similarly, Examples 1 and 2 demonstrate that hydroxyethyl methyl cellulose and microcrystalline cellulose can be used interchangeably in the puncture sealing agent without negatively affecting performance. Example 4 shows that the presence of a biomass-derived polymeric material such as cork powder surprisingly leads to a strong increase in viscosity and greatly enhances sealing performance in tires having an inner tube. From Example 5, which is not according to the present invention, it becomes evident that the presence of the additional polymer is important for both aging performance and sealing performance.

1. A puncture sealing agent, comprising
a rubber latex, a carbohydrate, an additional polymer, and an antifreeze agent,
wherein the rubber latex is present in an amount of 10 to 35 weight % per 100 weight % of the puncture sealing agent, and
the carbohydrate is a monosaccharide and/or a disaccharide and/or an oligosaccharide.

2. The puncture sealing agent according to claim 1,
wherein the rubber latex is a natural rubber latex, which is free of ammonia.

3. The puncture sealing agent according to claim 1,
wherein the carbohydrate is present in an amount of 0.1 to 15 weight % per 100 weight % of the puncture sealing agent.

4. The puncture sealing agent according to claim 1,
wherein the additional polymer is a polysaccharide which is different from the carbohydrate.

5. The puncture sealing agent according to claim 4,
wherein the polysaccharide is cellulose and/or a cellulose derivative.

6. The puncture sealing agent according to claim 1,
wherein the puncture sealing agent further comprises a biomass-derived polymeric material which is different from the additional polymer, the carbohydrate and the rubber latex.

7. The puncture sealing agent according to claim 6,
wherein the biomass-derived polymeric material, which is different from the additional polymer, the carbohydrate and the rubber latex, is present in an amount of 0.1 to 10 weight % per 100 weight % of the puncture sealing agent.

8. The puncture sealing agent according to claim 6, wherein a weight ratio of the amount of the biomass-derived polymeric material present in the puncture sealing agent to the amount of the additional polymer in the puncture sealing agent is in the range of 1:10 to 25:1.

9. The puncture sealing agent according to claim 1,
wherein the puncture sealing agent comprises the additional polymer, which is a water-soluble polysaccharide.

10. The puncture sealing agent according to claim 9,
wherein the water-soluble polysaccharide is a water-soluble cellulose ether.

11. The puncture sealing agent according to claim 9,
wherein the puncture sealing agent comprises the water-soluble additional polymer in an amount of 0.10 to 2.5 weight % of the puncture sealing agent.

12. The puncture sealing agent according to claim 9,
wherein the water-soluble additional polymer has a water solubility of at least 5 g/L at 20° C.

13. The puncture sealing agent according to claim 1,
wherein the puncture sealing agent is a bicycle tire puncture sealing agent.

14. A method comprising using the puncture sealing agent according to claim 1 to repair punctured tubeless tires.

15. A method comprising using the puncture sealing agent according to claim 1 to repair punctured tires having an inner tube, wherein the punctured tires having the inner tube are bicycle tires or e-scooter tires.

16. A method comprising using the puncture sealing agent according to claim 1 to-prevent punctures in tubeless tires.

17. A method comprising using the puncture sealing agent according to claim 1 to prevent punctures in tires having an inner tube.

18. A puncture sealing agent, comprising
a rubber latex, a carbohydrate, an additional polymer, and an antifreeze agent,
wherein the carbohydrate is a monosaccharide and/or a disaccharide and/or an oligosaccharide,
the additional polymer is a polysaccharide which is different from the carbohydrate, and
the polysaccharide is cellulose and/or a cellulose derivative.

19. The puncture sealing agent according to claim 18,
wherein the polysaccharide is microcrystalline cellulose, a cellulose ether containing a hydroxyethyl group, a cellulose ether containing a hydroxypropyl group, or a mixture thereof.

20. A puncture sealing agent, comprising
a rubber latex, a carbohydrate, an additional polymer, and an antifreeze agent,
wherein the carbohydrate is a monosaccharide and/or a disaccharide and/or an oligosaccharide, and
the additional polymer is present in an amount of 0.55 to 5 weight % per 100 weight % of the puncture sealing sealant.
